(19) United States
(12) Patent Application Publication
(10) Pub. No.: US 2009/0079863 A1
(43) Pub. Date: Mar. 26, 2009

(54) CAMERA MODULE, MANUFACTURING METHOD OF IMAGING APPARATUS AND HOT MELT MOLDING METHOD

(76) Inventors: Susumu AOKI, Ibaraki (JP); Takashi Hasuda, Ibaraki (JP)

Correspondence Address: BIRCH STEWART KOLASCH & BIRCH, PO BOX 747, FALLS CHURCH, VA, 22040-0747, US

(21) Appl. No.: 12/233,434

(22) Filed: Sep. 18, 2008

(30) Foreign Application Priority Data
Sep. 20, 2007 (JP) 2007-244317
Mar. 19, 2008 (JP) 2008-072593
May 8, 2008 (JP) 2008-122362

(51) Int. Cl. H04N 5/225

(52) U.S. Cl. 348/374; 348/E05.026

(57) ABSTRACT

The invention provides a camera module which can make a work for filling up a clearance between a pedestal mount and a circuit board in a post process unnecessary. The invention provides a camera module including a lens unit, an imaging element converting an incoming light formed by the lens unit into an electric signal and a pedestal mount attaching the lens unit thereto and storing the imaging element, in which a lower end portion of a side wall portion of the pedestal mount is provided with a bottom surface portion made of a thermoplastic resin melting at a reflow temperature.

### BACKGROUND OF THE INVENTION

(1) Field of the Invention

The present invention relates to a cameral module or the like, and more particularly to a camera module or the like, for example, mounted to a cellular phone or the like.

(2) Description of Related Art

In recent years, a camera system is mounted to various devices such as a cellular phone or the like. A camera module forming a subject image on an image sensor by using a micro lens is widely used in the camera system mentioned above.

With regard to the camera module mentioned above, for example, patent document 1 (JP-A-2004-304604) describes that a reliability of an electric connection between a compact camera module and a socket is improved by setting an attaching structure of the compact camera module to the socket such as to prevent a spring-like arm portion of the socket from coming into contact with the compact camera module.

In the case of a camera module using a package sensor in which an image sensor and a cover glass are integrated, a predetermined clearance is provided for preventing a pedestal mount from coming into contact with a circuit board, in order to securely solder between the pedestal mount storing the package sensor and the circuit board.

If such the clearance remains between the pedestal mount and the circuit board, a flare or the like is generated in the subject image formed on the image sensor due to a stray light caused by an illumination light or the like. Accordingly, it is necessary to fill in the clearance by an adhesive agent or the like.

However, since a work for filling up the clearance mentioned above is generally carried out after a reflow soldering process heating the circuit board mounting the camera module thereon by a predetermined heating furnace (a reflow furnace), a process of operation is increased, and the work causes a reduction in a productivity.

Further, in the case that an electromagnetic shielding (an EMI shielding) is applied to the camera module by a conductive coating formed on a surface of an independent metal cover and the pedestal mount, it is necessary to carry out a process of conducting the shielding portion with the circuit board by using a conductive adhesive agent or a solder, after the reflow soldering process.

Further, if the adhesive agent or the like for filling up the clearance is expanded on the circuit board, and runs over largely to an outer side from the pedestal mount, it is impossible to arrange electronic parts and patterns in a region of the circuit board in which the adhesive agent or the like runs over. Accordingly, it becomes hard to downsize.

### BRIEF SUMMARY OF THE INVENTION

The present invention is made for solving the technical object mentioned above. In other words, an object of the present invention is to provide a camera module which can make a work for filling up a clearance between a pedestal mount and a circuit board in a post process unnecessary, can conduct a shield portion with a circuit board at a time of a reflow heating, and can intend to improve a productivity and reduce a material cost.

An object of the present invention is to provide a camera module and a hot melt molding method which can make a work for filling up a clearance between a pedestal mount and a circuit board in a post process, and can achieve a downsizing by reducing a protruding portion of an adhesive agent or the like.

In this manner, in accordance with the present invention, there is provided a camera module including a lens unit, an imaging element converting an incoming light formed by the lens unit into an electric signal, and a pedestal mount attaching the lens unit thereto and storing the imaging element, wherein a lower end portion of a side wall portion of the pedestal mount is provided with a bottom surface portion made of a thermoplastic resin melting at a reflow temperature.

In this manner, in accordance with the present invention, there is provided a camera module including a lens unit, an imaging element converting an incoming light formed by the lens unit into an electric signal, and a pedestal mount attaching the lens unit thereto and storing the imaging element, wherein a lower end portion of a side wall portion of the pedestal mount is provided with a bottom surface portion made of a thermoplastic resin melting at a reflow temperature allowing a joint between the imaging element and a predetermined circuit board.

In this case, in the camera module to which the present invention is applied, it is preferable that the bottom surface portion is integrally formed with the side wall portion in accordance with a two-color forming method using a synthetic resin constructing the side wall portion of the pedestal mount and the thermoplastic resin constructing the bottom surface portion.

Further, it is preferable that the joint surface of the bottom surface portion to the side wall portion of the pedestal mount has a predetermined concavo-convex shape in such a manner that the bottom surface portion and the side wall portion are fitted to each other.

Further, it is preferable that the bottom surface portion has a taper shape in such a manner that a cross sectional width of the bottom surface portion becomes smaller than a cross sectional width of the side wall portion toward a leading end.

Further, it is preferable that the cross sectional width of the bottom surface portion is larger than the cross sectional width of the side wall portion.

Further, it is preferable that a viscosity of the thermoplastic resin constructing the bottom surface portion is between 3000 mPa·s and 10000 mPa·s.

Further, in the camera module to which the present invention is applied, it is preferable that the bottom surface portion is made of a thermoplastic resin composition including a thermoplastic resin melting at a reflow temperature and a conductive filler.

Further, it is preferable that a conductive membrane is formed on a surface of the pedestal mount.

Next, it is preferable that the joint surface of the side wall portion of the pedestal mount constructing the camera module to the bottom surface portion is formed as a taper shape in such a manner as to form a downward slope from an outer side of the side wall portion toward an inner side of the pedestal mount storing the imaging element.

Further, it is preferable that the joint surface of the side wall portion of the pedestal mount constructing the camera module to the bottom surface portion has a first taper shape formed in such a manner as to form a predetermined downward slope from an outer side of the side wall portion toward an inner side in a range between an outer peripheral surface of the side wall portion and about one half of a thickness of the side wall portion, a step formed in such a manner that the joint surface comes down approximately vertically in a direction of the circuit board at a point which is about one half of the thickness of the side wall portion, and a second taper portion formed in such a manner as to form a predetermined downward slope from a portion in which the step is formed toward an inner side of the side wall portion.

Further, it is preferable that the circuit board bonded to the imaging element has a step formed in such a manner that a portion provided with a terminal portion to which the bottom surface portion melting at the reflow temperature is bonded comes to a convex portion.

Further, it is preferable that the circuit board bonded to the imaging element has a step formed in such a manner that a portion provided with a terminal portion to which the bottom surface portion melting at the reflow temperature is bonded comes to a concave portion.

In this case, it is preferable that the reflow temperature allowing the joint between the imaging element and the circuit board is between 190° C. and 290° C.

In this case, it is preferable that the thermoplastic resin constructing the bottom surface portion is constituted by a hot melt adhesive agent.

Next, in accordance with the present invention, there is provided a manufacturing method of an imaging apparatus having a camera module provided with a pedestal mount storing an imaging element and a circuit board, including a mounting step of mounting the camera module on the circuit board to which a solder paste is applied at a predetermined position, and a heating step of heating the circuit board in which the camera module is mounted at the predetermined position, through a reflow furnace, wherein the method solders the imaging element of the camera module and the circuit board in the heating step, melts the bottom surface portion provided in a lower end portion of the pedestal mount of the camera module and made of a thermoplastic resin, and fills up a clearance between the pedestal mount and the circuit board.

In this case, it is preferable that the bottom surface portion provided in the lower end portion of the pedestal mount is formed by a hot melt adhesive agent.

Next, in accordance with the present invention, there is provided a manufacturing method of an imaging apparatus having a camera module in which an imaging element is stored in a pedestal mount to which a lens module is attached, and a circuit board bonded to the camera module, including a mounting step of mounting the camera module to the circuit board to which a solder paste is previously applied at a predetermined position, and setting a predetermined clearance between a bottom surface portion provided in a lower end of the pedestal mount of the camera module and made of a thermoplastic resin, and the circuit board, and a heating step of heating the circuit board mounting the camera module thereon in accordance with the mounting step by passing through a heating furnace, soldering the imaging element of the camera module and the circuit board, melting the bottom surface portion provided in the lower end of the pedestal mount of the camera module, and filling up a clearance provided between the pedestal mount and the circuit board.

In this case, it is preferable that the thermoplastic resin constructing the bottom surface portion provided in the lower end of the pedestal mount is constituted by a hot melt adhesive agent.

In accordance with the present invention, the work for filling up the clearance between the pedestal mount and the circuit board in the post process is not necessary.

In accordance with the present invention, there is provided a camera module including a lens unit, an imaging element converting an incoming light formed by the lens unit into an electric signal, and a pedestal mount having a side wall portion defining a space storing the imaging element and to which the lens unit is attached, wherein the pedestal mount is provided with a hot melt portion formed in the side wall portion, molten at a reflow temperature so as to be used for adhering with a board and made of a thermoplastic resin, and an outer surface groove portion formed in an outer surface of the side wall portion and formed in such a manner that an area of a lower surface of the side wall portion adhered to the board is partly decreased.

In this case, the structure may be made such that the pedestal mount is formed in an inner surface of the side wall portion, and is further provided with an inner surface groove portion formed in such a manner that the area of the lower surface of the side wall portion is partly decreased. Further, the structure may be made such that the inner surface groove portion is positioned in such a manner as to decrease the area of the lower surface of the other portions than the side wall portion in which the area of the lower surface is decreased by the outer surface groove portion. Further, the structure may be made such that the hot melt portion protrudes outward from the lower surface of the side wall portion in the outer surface groove portion. Further, the structure may be made such that a plurality of the outer surface groove portions are formed in the side wall portion, and a plurality of outer surface groove portions are positioned while sandwiching the imaging element stored in the pedestal mount therebetween.

In accordance with the present invention, there is provided a hot melt molding method of forming a hot melt portion made of a thermoplastic resin on a lower surface of a side wall portion of a pedestal mount to which a lens and an imaging element converting an incoming light formed by the lens into an electric signal are attached, by using an injection molding metal mold, including the steps of installing the pedestal mount in the injection molding metal mold in such a manner that a groove portion formed on an outer surface of the side wall portion is positioned at an injection port of the injection molding metal mold so as to partly decrease an area of the lower surface of the pedestal mount, injecting the thermoplastic resin in a molten state from the injection port, and picking up the pedestal mount from the injection molding metal mold after the thermoplastic resin is hardened.

In this case, the structure may be made such that a plurality of the groove portions are formed in the pedestal mount, and the pedestal mount is installed in the injection molding metal mold in such a manner that one of a plurality of groove portions is positioned in an air escape portion of the injection molding metal mold. Further, the structure may be made such that a portion protruding from the outer surface in the thermoplastic resin existing in the vicinity of the groove portion is cut after picking up the pedestal mount from the injection molding metal mold.

In accordance with the present invention, the work for filling up the clearance between the pedestal mount and the circuit board in the post process is not necessary, and it is possible to achieve a downsizing by decreasing the protruding portion of the adhesive agent or the like.

### BRIEF DESCRIPTION OF THE SEVERAL VIEWS OF THE DRAWING

FIG. 1 is a view explaining a camera module to which the present embodiment is applied;

FIG. 2 is an exploded perspective view of the camera module shown in FIG. 1;

FIG. 3 is a vertical cross sectional view of the camera module shown in FIG. 1;

FIGS. 4A-4D are views explaining an example of a joint surface between a side wall portion of a pedestal mount and a bottom surface portion;

FIGS. 5A-5C are views explaining a state in which the bottom surface portion is molten at a reflow temperature;

FIGS. 6A-6B are vertical cross sectional view of a second embodiment of the camera module;

FIG. 7 is a vertical cross sectional view of a third embodiment of the camera module;

FIGS. 8A-8E are views explaining an example of the joint surface between the side wall portion of the pedestal mount and the bottom surface portion;

FIGS. 9A-9E are view explaining a shape of a terminal portion of a circuit board;

FIGS. 10A-10C are views showing a pedestal mount elemental substance, in which FIG. 10A is a plan view, FIG. 10B is a front elevational view and FIG. 10C is a bottom elevational view;

FIGS. 11A-11B are plan views for explaining a state in which a hot melt portion formed in the pedestal mount is molten at a reflow temperature;

FIGS. 12A-12C are views showing a pedestal mount elemental substance in accordance with one modified embodiment, in which FIG. 12A is a plan view, FIG. 12B is a front elevational view and FIG. 12C is a bottom elevational view;

FIG. 13 is a plan view for explaining a state in which a hot melt portion formed in the pedestal mount in FIG. 12 is molten at a reflow temperature;

FIG. 14A is a bottom elevational view showing a pedestal mount elemental substance in accordance with the other modified embodiment;

FIG. 14B is a bottom elevational view showing a pedestal mount elemental substance in accordance with further the other embodiment;

FIGS. 15A-15B are views explaining a method of forming a hot melt portion in a pedestal mount, in which FIG. 15A is a perspective view of the pedestal mount and an injection molding metal mold, and FIG. 15B is a perspective view of an injection molding metal mold in accordance with one modified embodiment;

FIGS. 16A-16B are views explaining a method of forming a hot melt portion in a pedestal mount, in which FIG. 16A is a plan view of the pedestal mount and an injection molding metal mold, and FIG. 16B is a cross sectional view along a line Xb-Xb in FIG. 16A; and

FIGS. 17A-17B are views explaining a method of forming a hot melt portion in a pedestal mount, in which FIG. 17A is a plan view of an injection molding metal mold, and FIG. 17B is a plan view of the pedestal mount.

### DETAILED DESCRIPTION OF THE INVENTION

A description will be in detail given below of embodiments in accordance with the present invention. In this case, the present invention is not limited to the following embodiments, but can be variously modified within the scope of the present invention. Further, the used drawings are provided for explaining the present embodiments, and do not express an actual magnitude.

### FIRST EMBODIMENT

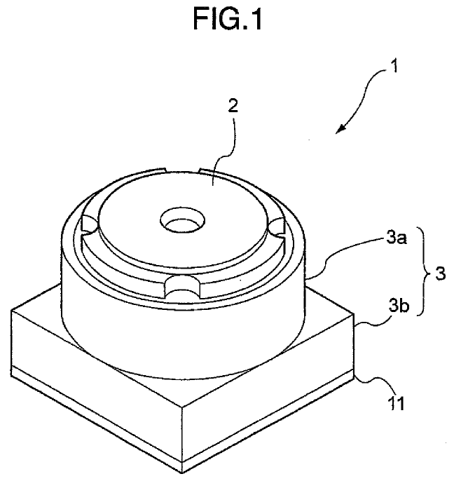

FIG. 1 is a view explaining a camera module 1 to which the present embodiment (a first embodiment) is applied. As shown in FIG. 1, the camera module 1 is provided with a lens unit 2 retaining a plurality of lenses (mentioned below), and a pedestal mount 3 mounting the lens unit 2. The pedestal mount 3 has a cylinder portion 3a to which the lens unit 2 is mounted, and a rectangular portion 3b integrally structured with the cylinder portion 3a, and a bottom surface portion 11 constituted by a thermoplastic resin is provided in a lower end of the rectangular portion 3b of the pedestal mount 3. The bottom surface portion 11 will be described later. In this case, a part obtained by attaching the lens unit 2 to the pedestal mount 3 may be called as a body tube.

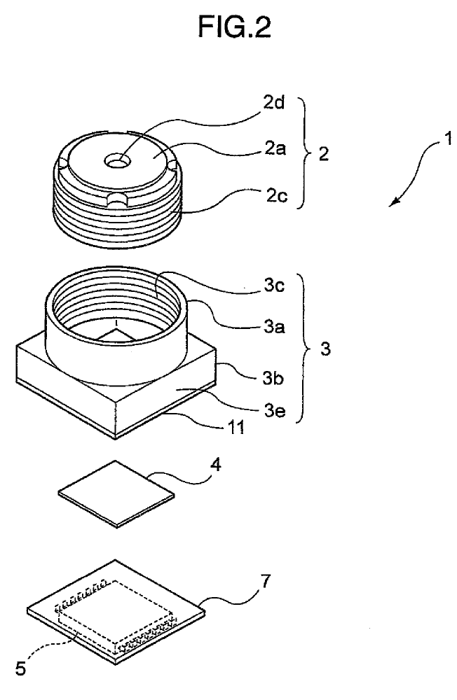

FIG. 2 is an exploded perspective view of the camera module 1 shown in FIG. 1. As shown in FIG. 2, the camera module 1 is provided with the lens unit 2 and the pedestal mount 3. Further, the camera module 1 is provided with a filter 4 removing a specific frequency component of an incoming light incoming to the lens unit 2, a sensor (an imaging element) 5 converting the incoming light into an electric signal, and a rectangular glass cover 7 arranged between the filter 4 and the sensor 5.

The lens unit 2 of the camera module 1 is constructed by a barrel (a holder) 2a accommodating a plurality of lenses in an inner portion. An opening portion 2d to which the light incomes is provided in an end surface of the barrel 2a, and a male thread 2c is formed on an outer peripheral surface of the barrel 2a.

As mentioned above, the cylinder portion 3a and the rectangular portion 3b of the pedestal mount 3 are integrally structured, and are structured such that an internal space of the cylinder portion 3a is continuous with an internal space of the rectangular portion 3b. Further, a female thread 3c is formed on an inner peripheral surface of the cylinder portion 3a so as to correspond to a male thread 2c formed on an outer peripheral surface of the barrel 2a of the lens unit 2 mentioned above. Further, a side wall portion 3e is formed in the rectangular portion 3b of the pedestal mount 3, and the bottom surface portion 11 is provided in a lower end of the side wall portion 3e.

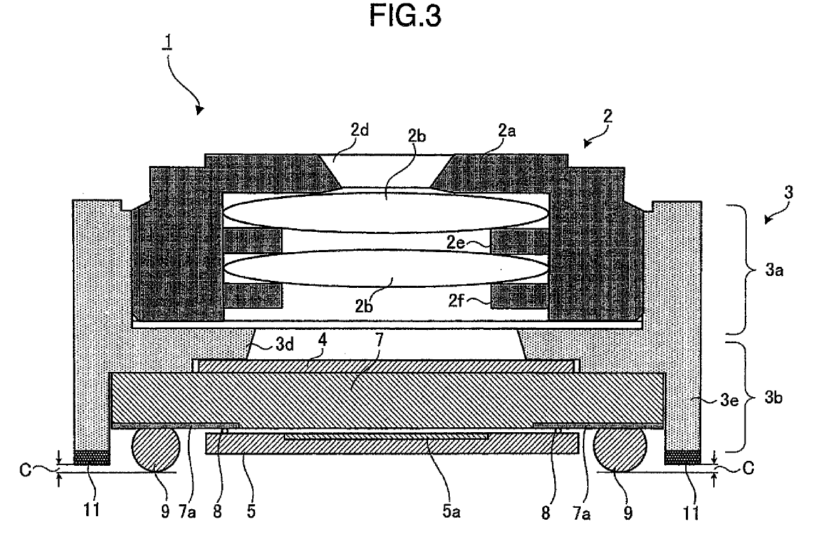

The lens unit 2 is attached by screwing to the cylinder portion 3a of the pedestal mount 3. In this case, the lens 2b (refer to FIG. 3) may be directly attached to the pedestal mount 3.

FIG. 3 is a vertical cross sectional view of the camera module 1 shown in FIGS. 1 and 2. As shown in FIG. 3, in the present embodiment, two lenses 2b are provided in the barrel 2a of the lens unit 2 main body.

The lens 2b is an optical element for passing an external light therethrough so as to form an image in a light receiving region (an imaging area) 5a of the sensor 5. In other words, the lens 2b forms a predetermined optical system in such a manner that the light incoming from the opening portion 2d forms an image on the sensor 5. In this case, the lens 2b can be constructed by a single lens or a plurality of lens group. The lens unit 2 is screwed into the cylinder portion 3a of the pedestal mount 3, and is firmly attached to the pedestal mount 3 by an adhesive agent after an image formation is regulated on the basis of a screw operation. Accordingly, a focusing of the lens unit 2 is achieved.

Further, an inner side of the barrel 2a is provided with an intermediate ring 2e positioned between two lenses 2b, and a lens presser foot 2f positioned in a lower side of two lenses 2b.

The intermediate ring 2e has a focusing function limiting a light intensity of the incoming light passing through the opening portion 2d. Further, the lens presser foot 2f presses two lenses 2b.

A flange portion 3d extending from an inner surface so as to be formed in such a manner as to narrow the internal space is provided in an inner side of the pedestal mount 3. The filter 4 is attached to the flange portion 3d of the pedestal mount 3.

In this case, the filter 4 is a thin member removing a specific frequency component of the external light. In the present embodiment, an infrared cut filter (IRCF) is used. If the filter 4 is attached to the flange portion 3d, the internal space of the pedestal mount 3 is comparted into two sections. The filter 4 is arranged in the vicinity of the sensor 5, thereby suppressing an influence of an irregular reflection.

A glass cover 7 to which the sensor 5 is firmly attached via a solder bump B is accommodated in an inner side of a region formed by being surrounded by the side wall portion 3e in the rectangular portion 3b of the pedestal mount 3. As shown in FIG. 3, the glass cover 7 is arranged between the filter 4 and the sensor 5, and the sensor 5 is firmly attached to the glass cover 7.

The sensor 5 is constituted by an image sensor (an imaging element) such as a charge coupled device (CCD), a complementary metal oxide semiconductor (CMOS) or the like. In the present embodiment, there is used a sensor having a chip scale package (CSP) structure. The sensor 5 generates an electric signal in correspondence to the light image formed in the light receiving region 5a via the lens unit 2 so as to output.

A wiring pattern 7a is previously provided in an outgoing surface (a lower surface) side of the glass cover 7. Further, a plurality of solder bumps 8 are provided in such a manner that the wiring pattern 7a and the sensor 5 are electrically and physically connected. As mentioned above, the sensor 5 is physically fixed (bonded) to the glass cover 7 by the solder bump B attached to the wiring pattern 7a, and is electrically connected to the wiring pattern 7a of the glass cover 7.

In this case, a clearance between the sensor 5 and the glass cover 7 is decided in accordance with a magnitude of the solder bump 8. Since it is easy to control the magnitude of the solder bump 8, it is possible to accurately position the sensor 5 and the glass cover 7. Further, the clearance between the sensor 5 and the glass cover 7 is averaged by positioning by a plurality of solder bumps 8.

A solder pump 9 is arranged at the other position of the wiring pattern 7a in the outgoing surface side of the glass cover 7. An electric connection between the glass cover 7 and a circuit board (not shown) is secured by the solder bump 9. In this case, the solder bump 9 is used as a spacer by which the sensor 5 fixed to the glass cover 7 and the circuit board come away from each other.

Next, a description will be given of a material of the lens unit 2 and the pedestal mount 3 constructing the camera module 1.

In the present embodiment, the barrel 2a of the lens unit 2 and the pedestal mount 3 have a light shielding performance, and are made of a synthetic resin having a heat resistance capable of resisting a reflow temperature at a time of a heating treatment in a heating furnace (a reflow furnace) mentioned below. In this case, the reflow furnace is constituted, for example, by an apparatus previously feeding a solder to a position at which an electric part or the like is connected on a mounting board such as a printed circuit board or the like, and carrying out a reflow and soldering work heating after arranging the electric part thereon. Further, the reflow temperature is a temperature at which the sensor (the imaging element) 5 and the circuit board (not shown) can be bonded.

In this case, it is desirable that the heat resisting temperature is normally equal to or higher than 200° C., and is preferably between 260 and 300° C.

As the synthetic resin having the heat resistance, for example, there can be listed up a liquid crystal polymer such as a condensation polymerization material between an ethylene terephthalate and a para hydroxyl benzoic acid, a condensation polymerization material between a phenol and a phthalic acid, and a para hydroxyl benzoic acid, a condensation polymerization material between a 2.6-hydroxy naphthoic acid and a para hydroxyl benzoic acid or the like, and a thermoplastic resin such as a poly phthal amide resin, a polyether ether ketone resin (PEEK), a thermoplastic polyimide or the like.

Further, as a material constructing the lens 2b, there can be listed up a synthetic resin such as a silicone resin or the like, a glass and the like.

Next, a description will be given of the bottom surface portion 11.

As shown in FIG. 3, the lens unit 2 has the bottom surface portion 11 in a lower end of the side wall portion 3e of the pedestal mount 3. The bottom surface portion 11 forms a predetermined clearance C between the pedestal mount 3 and a circuit board (not shown) mentioned below. In this case, in order to securely solder the pedestal mount 3 and the circuit board, the clearance C is previously set in such a manner that the pedestal mount 3 does not come into contact with the circuit board.

The bottom surface portion 11 is molten at the reflow temperature at a time of a heating treatment in a heating furnace (a reflow furnace) mentioned below, and is formed by a thermoplastic resin having a nature hanging out to the circuit board side so as to fill up the clearance C. In this case, the reflow temperature is normally in a range between 190° C. and 290° C., and is preferably in a range between 250° C. and 260° C.

As the thermoplastic resin mentioned above, for example, there can be listed up a material in which a viscosity at the reflow temperature is between 3000 mPa·s and 10000 mPa·s. Specifically, there can be listed up a polycarbonate resin, a hot melt adhesive agent and the like. Among them, as the holt melt adhesive agent, for example, there can be listed up a polyamide resin hot melt adhesive agent having a polyamide resin such as 11 nylon, 12 nylon or the like as a main component, a polyurethane resin hot melt adhesive agent having a thermoplastic polyurethane resin as a main component, a polyolefin resin hot melt adhesive agent having an amorphous polypropylene resin as a main component and the like. In this case, in the case of using the hot melt adhesive agent, a black one is preferable for preventing a reflection.

The pedestal mount 3 and the bottom surface portion 11 mentioned above are integrally formed. As a method of integrally forming the pedestal mount 3 and the bottom surface portion 11, for example, there can be listed up a method of adhering and fixing the bottom surface portion 11 to the lower end of the side wall portion 3e by a predetermined adhesive agent, a method of integrally forming the pedestal mount 3 and the bottom surface portion 11 in accordance with a two-color molding method, a method of forming the bottom surface portion 11 in the lower end of the pedestal mount 3 in accordance with an outsert molding and the like. In this case, the two-color molding method is a method of welding two formed bodies and forming an integral formed product, for example, by injecting a first resin to a first cavity so as to form a first formed body, and next injecting a second resin to a second cavity which is adjacent to the first cavity so as to form a second formed body.

In the present embodiment, the pedestal mount 3 and the bottom surface portion 11 are integrally formed in accordance with the two-color molding method. In accordance with the two-color molding method, a process can be preferably omitted.

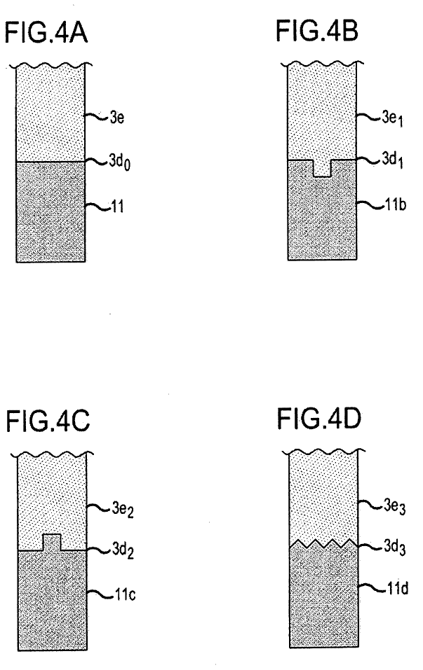

FIG. 4 is a view explaining an example of the joint surface between the side wall portion 3e of the pedestal mount 3 and the bottom surface portion 11. FIG. 4A is a view showing a state in which the side wall portion 3e and the bottom surface portion 11 are integrally formed, and a flat joint surface 3d0 is formed. As mentioned above, as an integrally forming method, there can be listed up the fixation by the adhesive agent and the integral formation in accordance with the two-color molding method.

FIG. 4B is a view showing a state in which a concavo-convex joint surface 3d1 is formed. As shown in FIG. 4B, a convex shape is formed in a lower side of a side wall portion 3e1, a concave portion corresponding to the convex shape of the side wall portion 3e1 is formed in a bottom surface portion 11b, and these convex portion and concave portion are fitted to each other. An adhesion area between the side wall portion 3e1 and the bottom surface portion 11b is increased by forming the joint surface 3d1 as the concavo-convex shape, and a close attaching characteristic is improved.

FIG. 4C is a view showing a state in which a concavo-convex joint surface 3d2 is formed. As shown in FIG. 4C, a concave shape is formed in an upper side of a side wall portion 3e2, a convex portion corresponding to the concave shape of the side wall portion 3e2 is formed in a bottom surface portion 11c, and these concave portion and convex portion are fitted to each other.

FIG. 4D is a view showing a state in which a wave-formed joint surface 3d3 is formed. As shown in FIG. 4D, a wave shape is formed in a lower end of a side wall portion 3e3 and an upper surface of a bottom surface portion 11d, respectively, and the lower end of the side wall portion 3e3 and the upper surface of the bottom surface portion 11d are fitted to each other.

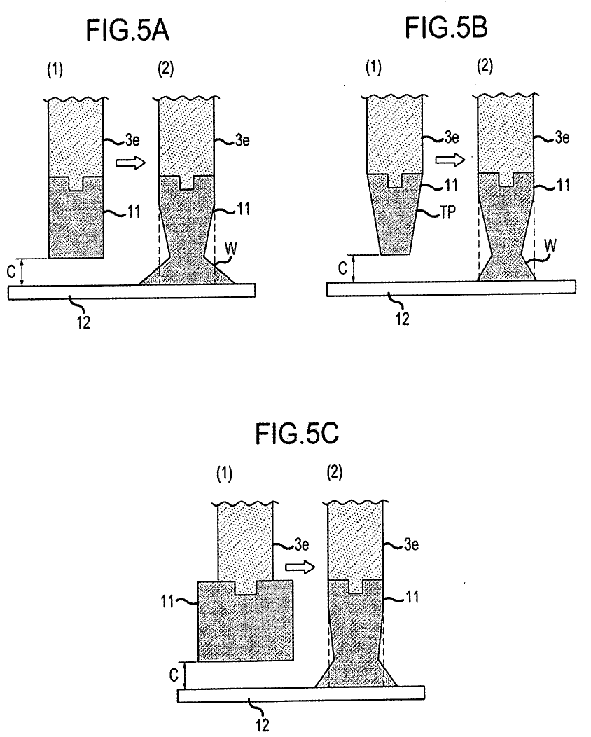

FIG. 5 is a view explaining a state in which the bottom surface portion 11 is molten at the reflow temperature. As shown in FIG. 5A, the bottom surface portion 11 (FIG. 5A(1)) made of the thermoplastic resin is molten at the reflow temperature, and hangs out to the circuit board 12 side, and the clearance C is filled (FIG. 5A(2)). At this time, a part of the melting thermoplastic resin flows in a flat surface direction of the circuit board 12, and there is a case that an expanded portion W having a greater width than a width of the side wall portion 3e is formed.

Accordingly, the width of the expanded portion W generated by the melting thermoplastic resin is suppressed (FIG. 5B(2)) by forming the bottom surface portion 11 as a shape having a taper shape TP in which a cross sectional width of the bottom surface portion 11 becomes smaller than a cross sectional width of the side wall portion 3e toward a leading end (FIG. 5B(1)), as shown in FIG. 58. Therefore, it is possible to correspond to a space saving and a downsizing of the apparatus.

Further, FIG. 5C is a view explaining a case that the cross sectional width of the bottom surface portion 11 is larger than the cross sectional width of the side wall portion 3e. In the case of a thin molding in which the cross sectional width of the bottom surface portion 11 is excessively small, there is a tendency that the bottom surface portion 11 becomes further thinner after being molten at the reflow temperature, and a shock resistance is lowered. In this case, it is possible to suppress the thinning of the melting thermoplastic resin (FIG. 5C(2)) by making the cross sectional width of the bottom surface portion 11 larger than the cross sectional width of the side wall portion 3e (FIG. 5C(1)). Accordingly, it is possible to reinforce the shock resistance of the bottom surface portion after being molten.

### SECOND EMBODIMENT

In this case, in the present embodiment, the description is given of the case that the predetermined clearance C is provided between the bottom surface portion 11 and the circuit board (not shown), as shown in FIG. 3, however, the present invention can be applied to a case that the clearance C is not provided.

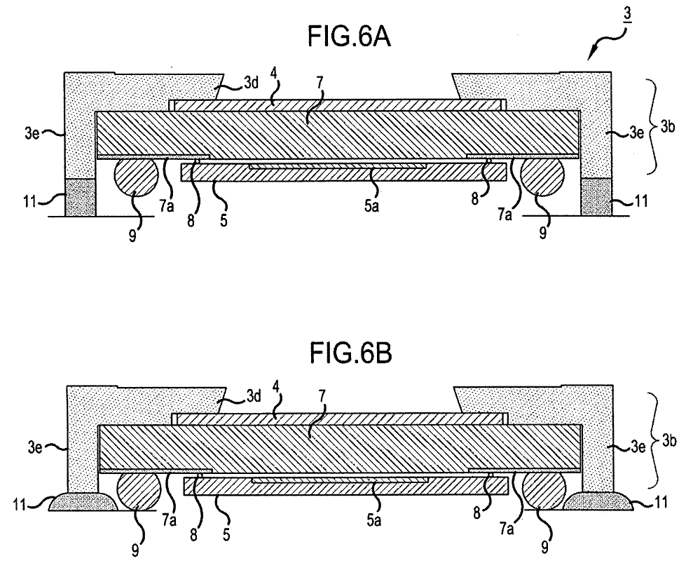

FIG. 6 is a vertical cross sectional view of a second embodiment of the camera module. FIGS. 6A and 6B show vertical cross sectional views of a lower portion from the rectangular portion 3b of the pedestal mount 3 constructing the camera module, and the cylinder portion 3a and the lens unit 2 are omitted. In this case, the same reference numerals are attached to the same structure as the camera module 1 shown in FIG. 3, and a description thereof will be omitted.

As shown in FIG. 6A, the bottom surface portion 11 made of the thermoplastic resin is provided in the lower end of the side wall portion 3e constructing the rectangular portion 3b of the pedestal mount 3 in such a manner as to come into contact with the circuit board (not shown) and not to form the clearance C between the pedestal mount 3 and the circuit board.

Further, a solder bump 9 is arranged in the wiring pattern 7a in the outgoing surface side of the glass cover 7.

Next, as shown in FIG. 6B, the bottom surface portion 11 is molten at the reflow temperature at a time of the heating process in the reflow furnace, and hangs over on the circuit board, whereby the rectangular portion 3b of the pedestal mount 3 settles down. At this time, the solder bump 9 arranged in the wiring pattern 7a comes into contact with a mounting portion (a solder paste applying portion) previously provided on the circuit board, and a solder mount can be achieved.

Next, a description will be given of a manufacturing method of an imaging apparatus having the camera module 1 and the circuit board, to which the present embodiment is applied.

The camera module 1 is structured, first of all, such that the lens unit 2 is temporarily screwed to the cylinder portion 3a of the pedestal mount 3, and the filter 4 is attached to a flange portion 3d of the pedestal mount 3. At this time, the sensor 5 is previously bonded and firmly attached to the glass cover 7 by a plurality of solder bumps 8 in a state in which a light receiving region 5a is directed to the glass cover 7.

Next, the glass cover bonded to the sensor 5 is fitted to a region formed by being surrounded by the side wall portion 3e of the pedestal mount 3.

Thereafter, an adhesive agent is poured into a gap between a side end surface of the fitted glass cover 7 and the side wall portion 3e of the pedestal mount 3, and the glass cover 7 and the pedestal mount 3 are adhered. In this case, the adhesive agent may be previously poured into the pedestal mount 3 so as to be adhered, before fitting the glass cover 7 to which the sensor 5 is bonded. At this time, the gap between the side end surface of the glass cover 7 and the side wall portion 3e becomes minimum. Accordingly, if the glass cover 7 is fitted to the pedestal mount 3, the light receiving region 5a of the sensor 5 is optically positioned in an image forming region of the lens 2b, and optical axes in vertical and horizontal directions are regulated. Thereafter, the lens unit 2 is firmly attached to the pedestal mount 3 by the adhesive agent after the image formation is regulated, whereby an assembly of the camera module 1 is finished.

Subsequently, a description will be given below of a process in which the camera module 1 assembled as mentioned above is mounted to the circuit board (not shown) by an automatic mounting machine (mounter).

The camera module 1 in which the assembly is finished is mounted to a reel. Further, the reel mounting the camera module 1 is set to the mounter and the mounter is activated, whereby a mounting process is started. The mounter picks up the camera module 1 from the reel, and mounts at a predetermined position of the circuit board (a mounting step). The solder paste is previously printed at a position at which the camera module 1 is mounted on the circuit board, and if the mounter mounts the camera module 1 at the predetermined position, the camera module 1 is temporarily fixed. Subsequently, the mounter mounts the other electronic parts on the circuit board, and the mounting work is finished. In this case, the camera module 1 may be picked up from a tray in place of the reel.

Next, the circuit board mounting the camera module 1 is transferred to the reflow furnace. In the reflow furnace, the circuit board is heated for some tens second at a temperature (for example, 260° C. or higher) at which the solder melts, and the soldering is carried out (a heating step). At this time, the solder bump 9 arranged in the wiring pattern 7a of the glass cover 7 of the camera module 1 melts, and is solder bonded to the terminal (not shown) previously formed on the circuit board. Accordingly, the sensor 5 within the camera module 1 and a signal processing portion on the circuit board are electrically connected.

At this time, the bottom surface portion 11 provided in a lower end of the pedestal mount 3 of the camera module 1 and made of the thermoplastic resin is molten at the reflow temperature, and the clearance C between the pedestal mount 3 and the circuit board is filled. Accordingly, an inner side of the region surrounded by the side wall portion 3e of the pedestal mount 3 is light shielded.

As mentioned above, in the manufacturing method of the imaging apparatus having the camera module 1 and the circuit board, the work for filling up the clearance C between the pedestal mount 3 and the circuit board in the post process is not necessary by using the camera module 1 to which the present embodiment is applied. Accordingly, it is possible to intend to improve a productivity and reduce a material cost.

In this case, the filter 4 may be fitted to a concave portion provided in the pedestal mount 3 in addition to being attached to the pedestal mount 3, and may be pinched by the glass cover 7 and the pedestal mount 3.

The camera module 1 described in the present embodiment can be applied to a cellular phone as one example of a mobile device mounting the camera module thereon, for example, a camera mounted to a personal computer or a personal digital assistant (PDA), a camera mounted to a motor vehicle, a surveillance camera or the like.

### THIRD EMBODIMENT

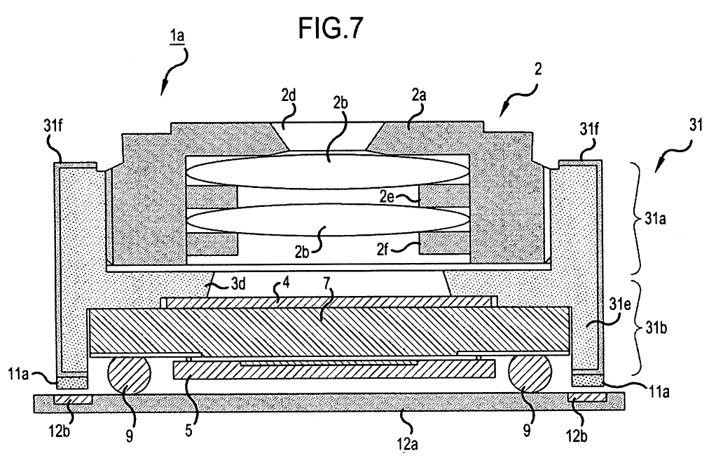

FIG. 7 is a vertical cross sectional view of a third embodiment of the camera module. The same reference numerals are attached to the same structures as those of the camera module 1 shown in FIG. 3, and a description thereof will be omitted.

The camera module 1a shown in FIG. 7 is structured such that a conductive membrane 31f is formed in a surface of a side wall portion 31e of a pedestal mount 31 (cylinder portion 31a and a rectangular portion 31b, and a whole is electromagnetically shielded.

Further, a bottom surface portion 11a is provided in a lower end of the side wall portion 31e of the pedestal mount 31 so as to be integrally formed with the side wall portion 31e. In this case, the bottom surface portion 11a is constructed by a thermoplastic resin composition including a thermoplastic resin melting at a reflow temperature and a conductive filler.

As shown in FIG. 7, the bottom surface portion 11a forms a predetermined clearance between the pedestal mount 31 and the terminal portion 12b of the circuit board 12a. Further, the bottom surface portion 11a is molten at the reflow temperature at a time of the heating process in the reflow furnace, whereby the clearance is filled, and the conductive membrane 31f of the pedestal mount 31 is conducted with the terminal portion 12b of the circuit board 12a, so that a shield effect can be obtained.

In this case, as the conductive membrane 31f, for example, there can be listed up a coated film of an electric conductive coating obtained by dispersing a conductive filler of a stainless, a copper, a nickel, a silver or the like, to a vehicle of an acrylic resin, an urethane resin or the like, a plating membrane formed in accordance with an electroless plating method by using a copper, a nickel or the like, a vapor deposition film formed by using an aluminum or the like, and the like.

Further, in the present embodiment, it is possible to apply an electromagnetic shield performance to the pedestal mount 31 itself by adjusting a combined resin compound obtained by blending a conductive filler such as a copper fiber, an aluminum flake, a stainless fiber or the like, and molding the pedestal mount 31 by using this. As the synthetic resin, there can be listed up the same structure as mentioned above.

The conductive membrane 31f can be conducted with the pedestal mount 31, and if the bottom surface portion 11a constructed by the thermoplastic resin composition including the conductive filler is molten, the conductive membrane 31f can be conducted with the terminal portion 12b of the circuit board 12a.

Accordingly, it is not necessary to carry out a step of fixing the shield portion to the circuit board 12a by using the conductive adhesive agent or the solder, which is conventionally carried out as the post process of the reflow soldering process, and a producing efficiency is improved. Further, a mounting area of an adhesion width in a potting adhesion which has been required conventionally is reduced. Further, since an independent metal cover is not necessary, a material cost is reduced.

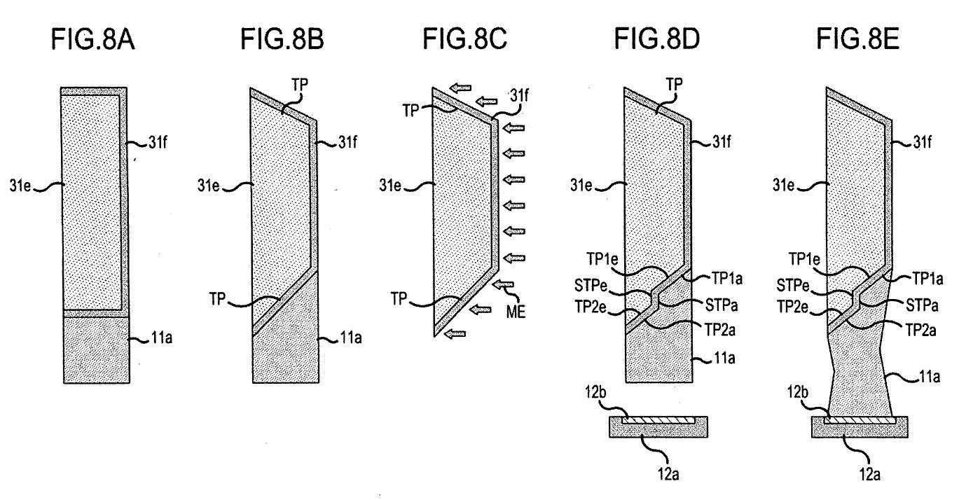

FIG. 8 is a view explaining an example of a joint surface between the side wall portion 31e of the pedestal mount 31 and the bottom surface portion 11a. As shown in FIG. 8A, the bottom surface portion 11a is fixed to the lower end of the side wall portion 31e via the conductive membrane 31f previously formed on the surface of the side wall portion 31e.

FIGS. 8B and 8C are views showing a joint surface in which a taper shape TP is formed. As shown in FIG. 8B, the taper shape TP is formed in the lower end of the side wall portion 31e so as to form a down slope from an outer side toward an inner side. In accordance with this, a taper shape TP corresponding to the taper shape TP of the side wall portion 31e is formed in the bottom surface portion 11a. In this case, in the present embodiment, a taper shape TP is formed in an upper end of the side wall portion 31e so as to form an up slope from an outer side toward an inner side.

As shown in FIG. 5C, it is possible to easily form the conductive membrane 31f in accordance with a vacuum deposition process from one direction or the like by forming the taper shape TP in the lower end and the upper end of the side wall portion 31e, for example, by using a metal ME such as an aluminum or the like.

Next, FIGS. 8D and 8E are views showing a joint surface in which the taper shape TP further has a step STP. As shown in FIG. 8D, the lower end of the side wall portion 31e of the pedestal mount 31 (refer to FIG. 7) has a first taper shape TP1e formed so as to have a predetermined down slope from an outer side of the side wall portion 31e toward an inner side in a range from an outer peripheral surface of the side wall portion 31e to about one half the thickness of the side wall portion 31e, a step STPe formed in such a manner that the joint surface comes down approximately vertically in a direction of the circuit board 12a at a point which is about one half the thickness of the side wall portion 31e, and a second taper shape TP2e formed so as to have a predetermined down slope from a portion where the step STPe is formed toward an inner side of the side wall portion 31e.

On the other hand, in correspondence to the taper shape having the step STPe formed in the lower end of the side wall portion 31e, a surface bonded to the lower end of the side wall portion 31e in the bottom surface portion 11a has a first taper shape TP1a formed so as to have a predetermined down slope from the outer side of the bottom surface portion 11a toward the inner side in a range from the outer peripheral surface of the bottom surface portion 11a to about one half the thickness of the bottom surface portion 11a, a step STPa formed in such a manner that the joint surface comes down approximately vertically in a direction of the circuit board 12a at a point which is about one half the thickness of the bottom surface portion 11a, and a second taper shape TP2a formed so as to have a predetermined down slope from a portion where the step STPa is formed toward an inner side of the bottom surface portion 11a.

As shown in FIG. 8D, in the joint portion between the lower end of the side wall portion 31e and the bottom surface portion 11a, the first taper shape TP1e formed in the lower end of the side wall portion 31e opposes to the first taper shape TP1a formed in the surface bonded to the lower end of the side wall portion 31e in the bottom surface portion 11a, the step STPe of the side wall portion 31e opposes to the step STPa of the bottom surface portion 11a, and the second taper shape TP2e of the side wall portion 31e opposes to the second taper shape TP2a of the bottom surface portion 11a, respectively, whereby an adhesiveness between the lower end of the side wall portion 31e and the bottom surface portion 11a is improved.

As shown in FIG. 5E, since the bottom surface portion 11a is molten, the conductive membrane 31f can conduct with the terminal portion 12b of the circuit board 12a.

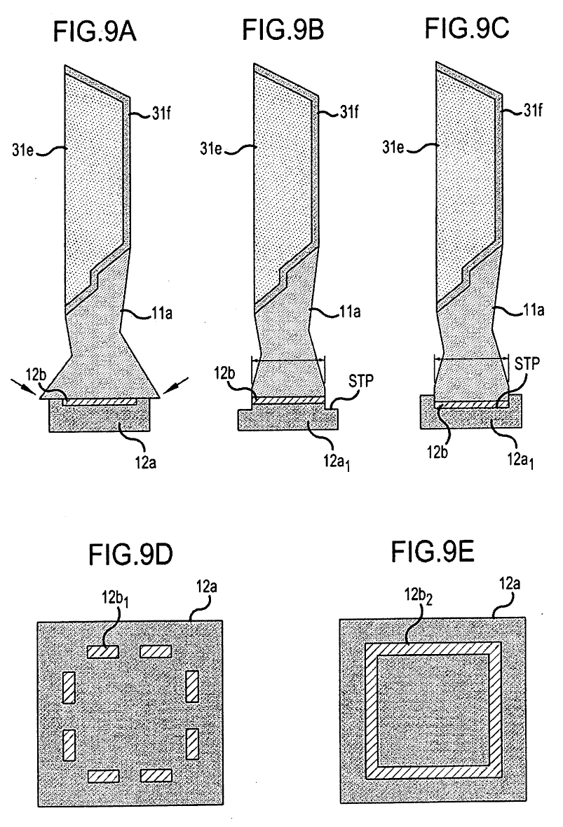

FIG. 9 is a view explaining a shape of the terminal portion 12b of the circuit board. As shown in FIG. 9A, there is a case that a part of the molten thermoplastic resin composition protrudes in a lateral direction of the terminal portion 12b provided in the circuit board 12a (an arrowed portion in the drawing) at a time when the bottom surface portion 11a is molten at the reflow temperature.

Next, as shown in FIG. 9B, it is possible to prevent the molten thermoplastic resin composition from protruding, by forming the step in the circuit board 12a1, in such a manner that the portion provided with the terminal portion 12b forms a convex portion. Further, as shown in FIG. 9C, the same effect can be obtained by forming the step in the circuit board 12a2 in such a manner that the portion provided with the terminal portion 12b forms a concave portion, and accommodating a part of the molten thermoplastic resin composition in the concave portion.

Further, in the present embodiment, as shown in FIG. 9D, the terminal portion 12b1 is formed in the circuit board 12a in accordance with an intermittent wiring pattern in such a manner as to go around the bottom surface of the camera module 1a (refer to FIG. 7). Further, as shown in FIG. 9E, since the terminal portion 12b2 is formed in the circuit board 12a in accordance with a continuous wiring pattern, a ground contact area is increased, and a shield effect is reinforced.

Next, a description will be given in detail of a hot melt molding method.

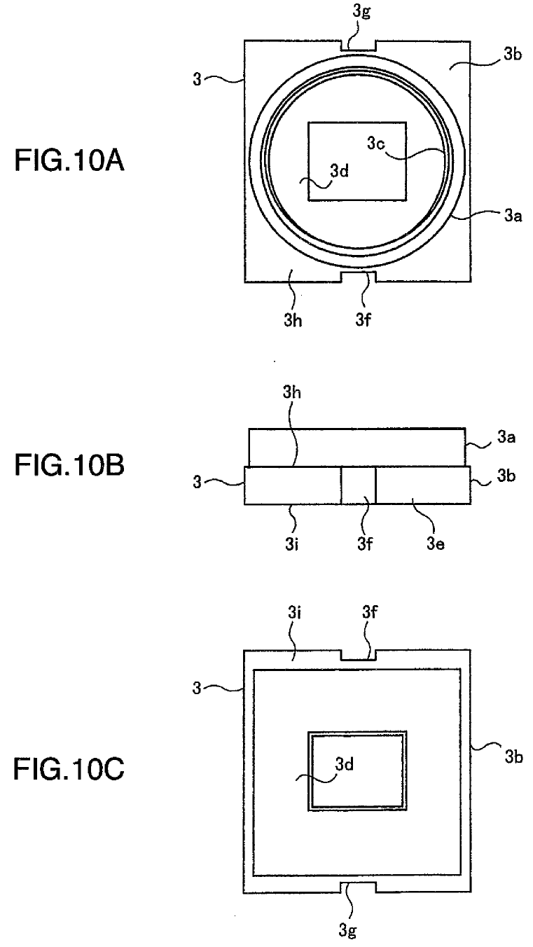

FIGS. 10A to 10C are views showing a pedestal mount 3 elemental substance, in which FIG. 10A is a plan view, FIG. 10B is a front elevational view, and FIG. 10C is a bottom elevational view.

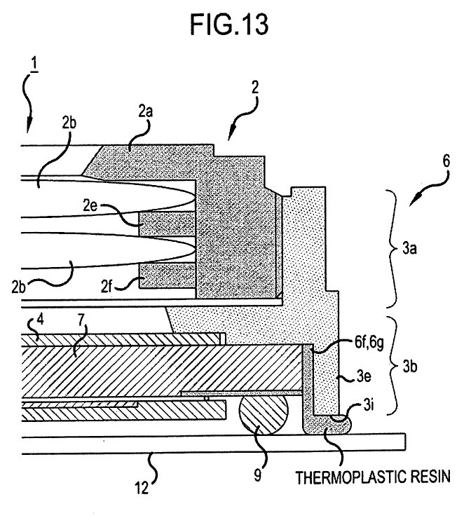

As shown in FIGS. 10A to 10C, the pedestal mount 3 is structured such that groove portions 3f and 3g are formed as one example of the outer surface groove portion in the side wall portion 3e of the rectangular portion 3b. The groove portions 3f and 3g are formed in the outer surface (an outer peripheral surface and an outer side) of the side wall portion 3e. Describing further, the groove portions 3f and 3g are formed in such a manner as to cut between an upper surface portion 3h and a bottom surface portion (a lower surface of the side wall portion) 3i of the rectangular portion 3b all over. Accordingly, the groove portions 3f and 3g appear in the plan view (refer to FIG. 10A) and the bottom elevational view (refer to FIG. 10C). As mentioned above, the groove portions 3f and 3g are formed in the outer surface of the side wall portion 3e, and is formed in such a manner that an area of the bottom surface portion 3i of the side wall portion 3e adhered to the circuit board 12 (refer to FIG. 13) is partly reduced. The groove portions 3f and 3g can be said as a structure for forming a thin portion in which the thickness of the bottom surface portion 3i becomes partly thin. In this case, the hot melt portion 11 mentioned above is formed in the bottom surface portion 3i (refer to FIG. 3).

Further, the groove portions 3f and 3g are formed in two side wall portions 3e opposing to each other among four side wall portions 3e. In other words, the groove portions 3f and 3g are positioned while sandwiching the sensor 5 therebetween in a state in which the sensor 5 is stored in the pedestal mount 3. In addition, in the present embodiment, the groove portions 3f and 3g are formed in two side wall portions 3e, however, there can be considered that the groove portions 3f and 3g are formed in all of four side wall portions 3e.

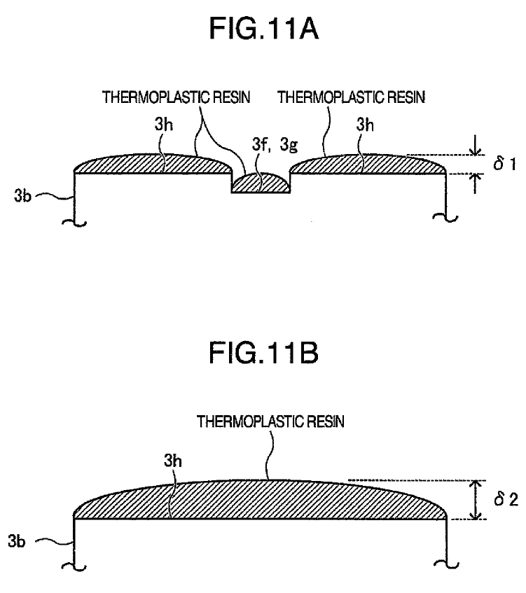

FIG. 11 is a plan view for explaining a state in which the hot melt portion 11 (refer to FIG. 3) formed in the pedestal mount 3 is molten at the reflow temperature.

If the pedestal mount 3 is heated to the reflow temperature, the hot melt portion 11 formed in the bottom surface portion 3i (refer to FIG. 10) of the pedestal mount 3 is molten. At this time, as shown in FIG. 11, the melting thermoplastic resin of the hot melt portion 11 protrudes outward than the bottom surface portion 3i, on the basis of a surface tension. The protrusion mentioned above is not preferable in the case of intending to downsize the circuit board 12 (refer to FIG. 13). If the groove portions 3f and 3g are formed in the outer surface of the side wall portion 3e such as the present embodiment, it is possible to reduce the protruding amount in comparison with the case that the groove portions 3f and 3g are not formed. In other words, a protruding amount δ1 in the case that the groove portions 3f and 3g are formed is smaller than a protruding amount δ2 in the case that the groove portions 3f and 3g are not formed (δ1<δ2). Further, since the groove portions 3f and 3g are positioned in the center portion of the line of the side wall portion 3e, it is possible to effectively reduce the protruding amount.

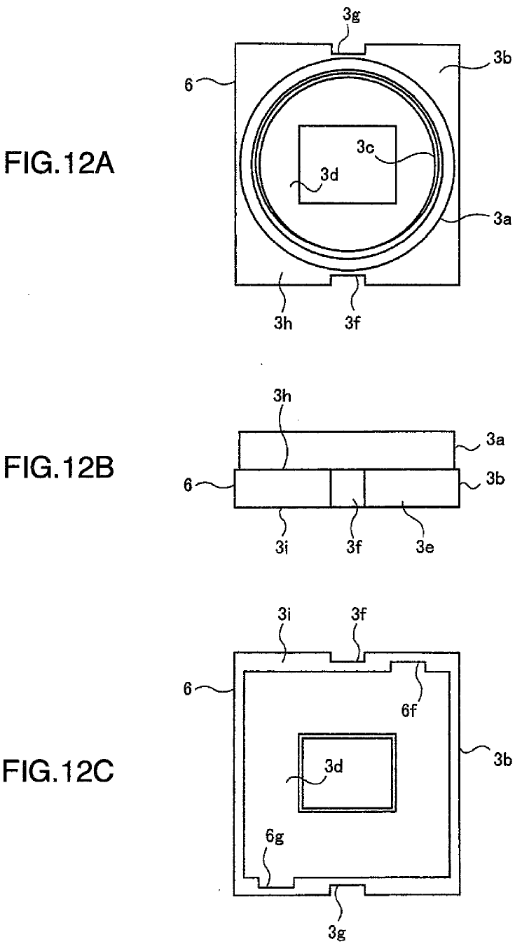

FIGS. 12A, 12B and 12C are views showing a pedestal mount 6 elemental substance in accordance with one modified embodiment, in which FIG. 12A is a plan view, FIG. 12B is a front elevational view and FIG. 12C is a bottom elevational view. In this case, since the pedestal mount 6 is in common with the pedestal mount 3 in its basic structure, the same reference numerals are attached to the same portions as those of the pedestal mount 3, and there is a case that a description thereof will be omitted.

As shown in FIG. 12C, the pedestal mount 6 is structured such that groove portions 6f and 6g are formed as one example of the inner surface grove portion in the side wall portion 3e of the rectangular portion 3b. The groove portions 6f and 6g are formed in the inner surface (the inner peripheral surface, the inner side) of the side wall portion 3e. As mentioned above, the groove portions 6f and 6g are formed in the inner surface of the side wall portion 3e, and are formed in such a manner that an area of the bottom surface portion 3i of the side wall portion Se adhered to the circuit board 12 (refer to FIG. 13) is partly reduced. The groove portions 6f and 6g can be called as a structure for forming a thin portion in which the thickness of the bottom surface portion 3i becomes partly thinner.

Describing further, the groove portion 6f is formed so as to be displaced with respect to the groove portion 3f formed in the outer side, and the groove portion 6g is formed so as to be displaced with respect to the groove portion 3g formed in the outer side. In other words, in the present embodiment, the groove portion 6f is formed alternately in adjacent to the groove portion 3f, and the groove portion 6g is formed alternately in adjacent to the groove portion 3g. Further, to put it in another way, the groove portions 6f and 6g are positioned in such a manner as to reduce the area of the bottom surface portion 3i in the other portions than the portion in which the area of the bottom surface portion 3i of the side wall portion 3e is reduced by the groove portions 3f and 3g. Accordingly, it is possible to avoid the matter that the side wall portion 3e becomes too thin in accordance with the formation of the groove portions 6f and 6g, and a necessary thickness on strength can be secured. In other words, as far as the necessary thickness on strength can be secured, there can be considered that the groove portion 6f is formed at the same position as the groove portion 3f, and the groove portion 6g is formed at the same position as the groove portion 3g.

FIG. 13 is a plan view for explaining a state in which the hot melt portion 11 formed in the pedestal mount 6 in FIG. 12 is molten at the reflow temperature.

As shown in FIG. 13, if the camera module 1 is heated to the reflow temperature in a state of being mounted to the circuit board 12, there can be considered that the hot melt portion 11 is molten, and the thermoplastic resin protrudes to the outer side in the outer surface of the side wall portion 3e on the basis of the surface tension, and gets into the gap with respect to the glass cover 7 in the inner surface of the side wall portion 3e. In the present embodiment, since the groove portions 6f and 6g are formed in the inner side of the side wall portion 3e, the thermoplastic resin getting into the gap between the pedestal mount 6 and the glass cover 7 stays in the groove portions 6f and 6g, thereby preventing the matter that the thermoplastic resin further gets into the gap between the pedestal mount 6 and the filter 4 and the gap between the filter 4 and the glass cover 7 from being generated. In particular, in the case of employing the structure that the glass cover 7 settles down at a time of the reflow heating, it is possible to prevent the matter that the thermoplastic resin is extruded in accordance with the settlement of the glass cover 7, and reaches the light receiving region in the upper surface side of the glass cover 7. Further, it is possible to reduce a total amount of the thermoplastic resin used as the hot melt portion 11 by providing the groove portions 6f and 6g in the inner surface of the side wall portion 3e such as the pedestal mount 6.

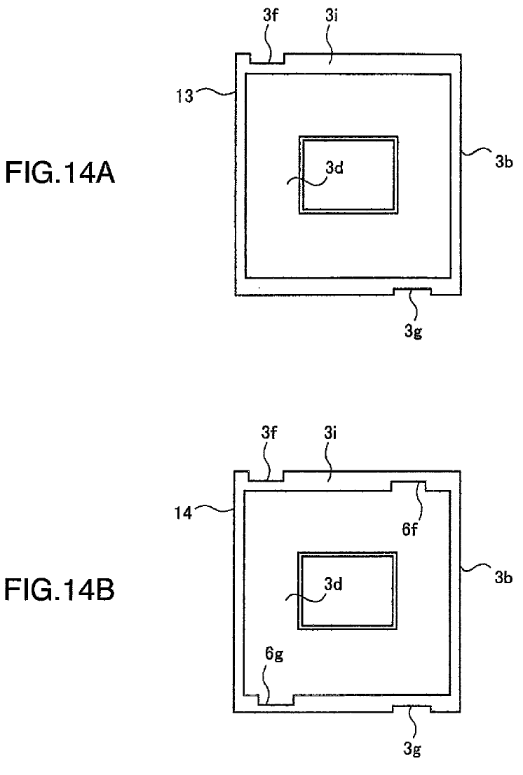

FIG. 14A is a bottom elevational view showing a pedestal mount 13 elemental substance in accordance with the other modified embodiment, and FIG. 14B is a bottom elevational view showing a pedestal mount 14 elemental substance in accordance with the other modified embodiment. In this case, since the pedestal mounts 13 and 14 are in common with the pedestal mounts 3 and 6 in their basic structures, the same reference numerals are used in the same portions as those of the pedestal mounts 3 and 6, and a description thereof will be omitted.

The groove portions 3f and 3g are formed at the other positions than the center portion of the side wall portion 3e (refer to FIG. 13), in the pedestal mount 13 shown in FIG. 14A. In other words, in the pedestal mount 3 shown in FIG. 10, the groove portions 3f and 3g are formed in the center portion of the side wall portion 3e, however, the positions of the groove portions 3f and 3g are not limited to this, in the present embodiment. Describing further, in the case of the pedestal mount 3 shown in FIG. 10, the outer diameter of the cylinder portion 3a is smaller than the outside dimension of the rectangular portion 3b. Accordingly, it is possible to arrange the groove portions 3f and 3g in the center portion of the side wall portion 3e. Accordingly, for example, in the case that it is necessary to make the outer diameter of the cylinder portion 3a identical with the outside dimension of the rectangular portion 3b, the present embodiment can be applied by forming the groove portions 3f and 3g at positions which are eccentric in any direction from the center portion.

The groove portions 6f and 6g are formed in the inner surface of the side wall portion 3e (refer to FIG. 13), in the pedestal mount 14 shown in FIG. 14B. In other words, the pedestal mount 14 is structured such that the groove portions 6f and 6g are added to the pedestal mount 13. In the case of the pedestal mount 14, a clearance between the groove portion 3f and the groove portion 6f is larger than that in the case of the pedestal mount 6 (refer to FIG. 12), and a clearance between the groove portion 3g and the groove portion 6g is larger than that in the case of the pedestal mount 6 (refer to FIG. 12). The clearance mentioned above can be appropriately decided in accordance with terms and conditions on the design.

Next, a description will be given of a method of forming the hot melt portion 11 in the pedestal mount 3. In this case, the hot melt molding method described below can be applied to any of the pedestal mounts 3, 6, 13 and 14, and a description will be given below of a hot melt molding method of the pedestal mount 3 as one example.

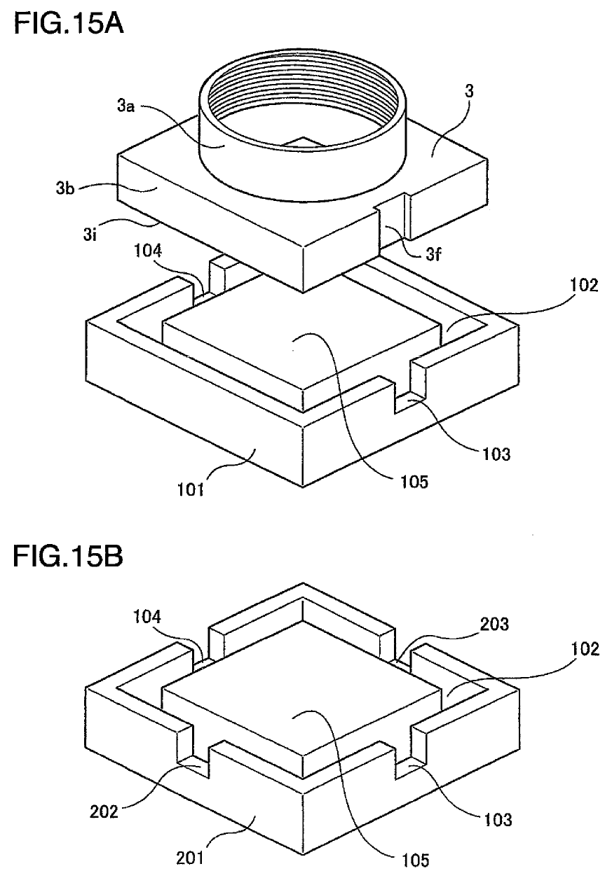

FIGS. 15A and 15B are views explaining a method of forming the hot melt portion 11 (refer to FIG. 1) in the pedestal mount 3, in which FIG. 15A is a perspective view of the pedestal mount 3 and an injection molding metal mold 101, and FIG. 15B is a perspective view of an injection molding metal mold 201 in accordance with one modified embodiment.

The pedestal mount 3, for example, manufactured in accordance with an injection molding is installed in the injection molding metal mold 101 for carrying out the hot melt molding. As shown in FIG. 15A, the injection molding metal mold 101 has a depression portion 102 for the hot melt molding, an injection port 103 formed in such a manner as to be connected to the depression portion 102 and injecting the thermoplastic resin, and an air escape portion 104 formed in such a manner as to be connected to the depression portion 102 and positioned in an opposite side to the injection port 103. Further, the injection molding metal mold 101 has a mounting portion 105 for mounting the pedestal mount 3.

In this case, an injection molding metal mold 201 shown in FIG. 15B may be employed in place of the injection molding metal mold 101 shown in FIG. 15A. The injection molding metal mold 201 has air discharge ports 202 and 203 in the middle of the depression portion 102 between the injection port 103 and the air escape portion 104. The other structures of the injection molding metal mold 201 are the same as those of the injection molding metal mold 101. Since the injection molding metal mold 201 has the air discharge ports 202 and 203 mentioned above, an air vent at a time of the injection molding can be smoothly carried out, and a flowing characteristic of the thermoplastic resin is improved.

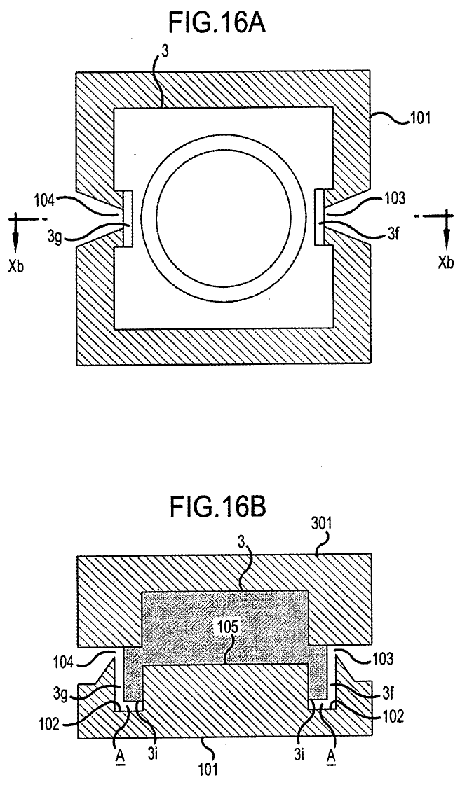

FIGS. 16A and 16B are views explaining a method of forming the hot melt portion 11 (refer to FIG. 3) in the pedestal mount 3, in which FIG. 16A is a plan view of a state in which the pedestal mount 3 is installed in the injection molding metal mold 101, and FIG. 16B is a cross sectional view along a line Xb-Xb in FIG. 16A.

As shown in FIG. 16A, the pedestal mount 3 is installed in an installation portion 105 (refer to FIG. 16B) of the injection molding metal mold 101. Describing further, the injection port 103 of the injection molding metal mold 101 protrudes to the groove portion 3f side of the pedestal mount 3. In other words, the injection port 103 of the injection molding metal mold 101 is formed in such a manner that an opening region of the groove portion 3f of the pedestal mount 3 installed in the injection molding metal mold 101 becomes narrower.

Further, as shown in FIG. 16B, a jig 301 is installed in the injection molding metal mold 101 so as to be aligned with the injection molding metal mold 101. In this state, the bottom surface portion 3i of the pedestal mount 3 is positioned in the depression portion 102 of the injection molding metal mold 101, and a space A for circulating the thermoplastic resin is formed with respect to the bottom surface portion 3i of the pedestal mount 3, within the depression portion 102. Further, the space A is communicated with the injection port 103 of the injection molding metal mold 101 via the groove portion 3f of the pedestal mount 3, and is communicated with the air escape portion 104 of the injection molding metal mold 101 via the groove portion 3g of the pedestal mount 3. Describing further, the groove portion 3f of the pedestal mount 3 is used as a gate. The groove portion 3g forms an escape of the air within the injection molding metal mold 101 at a time of the injection, the flowing characteristic of the thermoplastic resin is improved, and it is possible to improve a molding characteristic. In addition, it is necessary to widen the injection port in the case of setting the hot melt molding gate to the bottom surface portion, and there is generated a problem that the size is enlarged, however, such the problem is not generated in the present embodiment. In this case, it is preferable that the groove portions 3f and 3g are narrower than the depression portion 102.

Further, the jig 301 is provided for plugging the upper portion of the groove portion 3f in such a manner as to prevent the thermoplastic resin from flowing out of the upper portion of the groove portion 3f at a time of injecting the thermoplastic resin in the melting state from the groove portion 3f at a low pressure.

A description will be specifically given of the method of forming the hot melt portion 11.

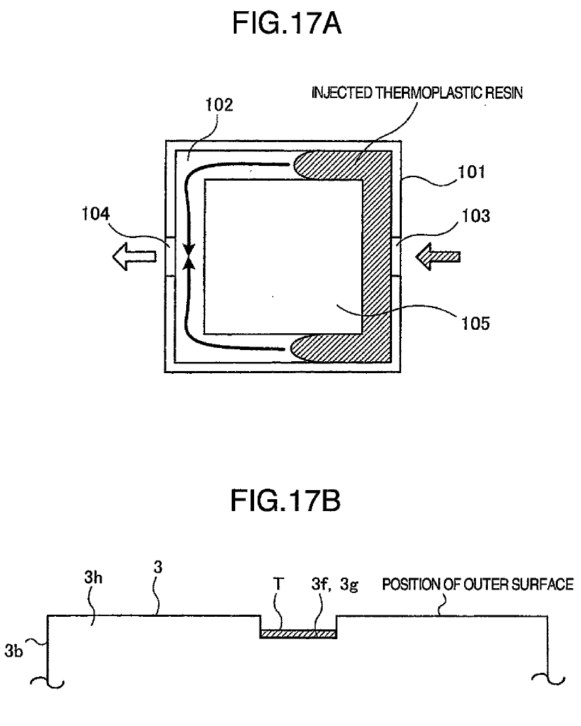

FIGS. 17A and 17B are views explaining the method of forming the hot melt portion 11 (refer to FIGS. 1 to 3) in the pedestal mount 3, in which FIG. 17A is a plan view of the injection molding metal mold 101 for explaining a flow of the thermoplastic resin at a time of forming the hot melt portion 11, and FIG. 17B is a plan view of the pedestal mount 3.

The thermoplastic resin in the melting state is injected from the injection port 103 of the injection molding metal mold 101 at the low pressure, after installing the pedestal mount 3 in the injection molding metal mold 101, and plugging the upper portion of the groove portion 3g by the jig 301 (refer to FIG. 16) in such a manner as to prevent the thermoplastic resin from flowing out of the upper portion of the groove portion 3g. Then, the thermoplastic resin is injected to the depression portion 102 from the injection port 103 as shown in FIG. 17A, and stops being injected if the thermoplastic resin goes forward along the depression portion 102 and reaches the air escape portion 104.

The thermoplastic resin is hardened thereafter by being cooled, and the hot melt portion 11 is formed in the bottom surface portion 3i (refer to FIG. 16) of the pedestal mount 3. Further, as shown in FIG. 17B, the pedestal mount 3 is picked up from the injection molding metal mold 101 and the jig 301, and the extra thermoplastic resin is removed. Specifically, the thermoplastic resin protruding from the groove portions 3f and 3g is cut. A cut trace T (a diagonal line portion in FIG. 17B) remains in the groove portions 3f and 3g even after the cutting mentioned above, however, is formed at a position which is at the back of the position of the outer surface of the side wall portion 3e. Accordingly, it is possible to prevent the cut trace T of the thermoplastic resin from protruding out of the outer surface of the side wall portion 3e. As mentioned above, the groove portions 3f and 3g are utilized as the gate for the hot melt molding, and it is possible to suppress the protruding amount caused by the cut trace T after the hot melt molding.

The camera module 1 described in the present embodiment can be applied to a cellular phone as one example of a mobile device mounting the camera module 1 thereon, for example, a camera mounted to a personal computer or a personal digital assistant (PDA), a camera mounted to a motor vehicle, a surveillance camera or the like.

1. A camera module comprising:
a lens unit:
an imaging element converting an incoming light formed by the lens unit into an electric signal; and
a pedestal mount attaching the lens unit thereto and storing the imaging element,
wherein a lower end portion of a side wall portion of the pedestal mount is provided with a bottom surface portion made of a thermoplastic resin melting at a reflow temperature.

2. A camera module comprising:
a lens unit:
an imaging element converting an incoming light formed by the lens unit into an electric signal; and
a pedestal mount attaching the lens unit thereto and storing the imaging element,
wherein a lower end portion of a side wall portion of the pedestal mount is provided with a bottom surface portion made of a thermoplastic resin melting at a reflow temperature allowing a joint between the imaging element and a predetermined circuit board.

3. A camera module as claimed in claim 1, wherein the bottom surface portion is integrally formed with the side wall portion hi accordance with a two-color forming method using a synthetic resin constructing the side wall portion of the pedestal mount and the thermoplastic resin constructing the bottom surface portion.

4. A camera module as claimed in claim 1, wherein the joint surface of the bottom surface portion to the side wall portion of the pedestal mount has a predetermined concavo-convex shape in such a manner that the bottom surface portion and the side wall portion are fitted to each other.

5. A camera module as claimed in claim 1, wherein the bottom surface portion has a taper shape in such a manner that a cross sectional width of the bottom surface portion becomes smaller than a cross sectional width of the side wall portion toward a leading end.

6. A camera module as claimed in claim 1, wherein the cross sectional width of the bottom surface portion is larger than the cross sectional width of the side wall portion.

7. A camera module as claimed in claim 1, wherein a viscosity of the thermoplastic resin constructing the bottom surface portion is between 3000 mpa·s and 10000 mpa·s.

8. A camera module as claimed in claim 1, wherein the bottom surface portion is made of a thermoplastic resin composition including a thermoplastic resin melting at a reflow temperature and a conductive filler.

9. A camera module as claimed in claim 1, wherein a conductive membrane is formed on a surface of the pedestal mount.

10. A camera module as claimed in claim 1, wherein the joint surface of the side wall portion of the pedestal mount to the bottom surface portion is formed as a taper shape in such a manner as to form a downward slope from an outer side of the side wall portion toward an inner side of the pedestal mount storing the imaging element.

11. A camera module as claimed in claim 1, wherein the joint surface of the side wall portion of the pedestal mount to the bottom surface portion has a first taper shape formed in such a manner as to form a predetermined downward slope from an outer side of the side wall portion toward an inner side in a range between an outer peripheral surface of the side wall portion and about one half of a thickness of the side wall portion, a step formed in such a manner that the joint surface comes down approximately vertically in a direction of the circuit board at a point which is about one half of the thickness of the side wall portion, and a second taper portion formed in such a manner as to form a predetermined downward slope from a portion in which the step is formed toward an inner side of the side wall portion.

12. A camera module as claimed in claim 1, wherein the circuit board bonded to the imaging element has a step formed in such a manner that a portion provided with a terminal portion to which the bottom surface portion melting at the reflow temperature is bonded comes to a convex portion.

13. A camera module as claimed in claim 1, wherein the circuit board bonded to the imaging element has a step formed in such a manner that a portion provided with a terminal portion to which the bottom surface portion melting at the reflow temperature is bonded comes to a concave portion.

14. A camera module as claimed in claim 1, wherein the reflow temperature is between 190° C. and 290° C.

15. A camera module as claimed in claim 1, wherein the thermoplastic resin constructing the bottom surface portion is constituted by a hot melt adhesive agent.

16. A manufacturing method of an imaging apparatus having a camera module provided with a pedestal mount storing an imaging element and a circuit board, comprising:
a mounting step of mounting the camera module on the circuit board to which a solder paste is applied at a predetermined position; and
a heating step of heating the circuit board in which the camera module is mounted at the predetermined position, through a reflow furnace,
wherein the method solders the imaging element of the camera module and the circuit board in the heating step, melts the bottom surface portion provided in a lower end portion of the pedestal mount of the camera module and made of a thermoplastic resin, and fills up a clearance between the pedestal mount and the circuit board.

17. A manufacturing method of an imaging apparatus having a camera module in which an imaging element is stored in a pedestal mount to which a lens module is attached, and a circuit board bonded to the camera module, comprising:
a mounting step of mounting the camera module to the circuit board to which a solder paste is previously applied at a predetermined position, and setting a predetermined clearance between a bottom surface portion provided in a lower end of the pedestal mount of the camera module and made of a thermoplastic resin, and the circuit board; and
a heating step of heating the circuit board mounting the camera module thereon in accordance with the mounting step by passing through a heating furnace, soldering the imaging element of the camera module and the circuit board, melting the bottom surface portion provided in the lower end of the pedestal mount of the camera module, and filling up a clearance provided between the pedestal mount and the circuit board.

18. A manufacturing method of an imaging apparatus as claimed in claim 17, wherein the thermoplastic resin constructing the bottom surface portion is constituted by a hot melt adhesive agent.

19. A camera module comprising:
a lens unit;
an imaging element converting an incoming light formed by the lens unit into an electric signal; and
a pedestal mount having a side wall portion defining a space storing the imaging element and to which the lens unit is attached,
wherein the pedestal mount is provided with a hot melt portion formed in the side wall portion, molten at a reflow temperature so as to be used for adhering with a board and made of a thermoplastic resin, and an outer surface groove portion formed in an outer surface of the side wall portion and formed in such a manner that an area of a lower surface of the side wall portion adhered to the board is partly decreased.

20. A camera module as claimed in claim 19, wherein the pedestal mount is formed in an inner surface of the side wall portion, and is further provided with an inner surface groove portion formed in such a manner that the area of the lower surface of the side wall portion is partly decreased.

21. A camera module as claimed in claim 20, wherein the inner surface groove portion is positioned in such a manner as to decrease the area of the lower surface of the other portions than the side wall portion in which the area of the lower surface is decreased by the outer surface groove portion.

22. A camera module as claimed in claim 19, wherein the hot melt portion protrudes outward from the lower surface of the side wall portion in the outer surface groove portion.

23. A camera module as claimed in claim 19, wherein a plurality of the outer surface groove portions are formed in the side wall portion, and a plurality of outer surface groove portions are positioned while sandwiching the imaging element stored in the pedestal mount therebetween.

24. A hot melt molding method of forming a hot melt portion made of a thermoplastic resin on a lower surface of a side wall portion of a pedestal mount to which a lens and an imaging element converting an incoming light formed by the lens into an electric signal are attached, by using an injection molding metal mold, comprising the steps of:
installing the pedestal mount in the injection molding metal mold in such a manner that a groove portion formed on an outer surface of the side wall portion is positioned at an injection port of the injection molding metal mold so as to partly decrease an area of the lower surface of the pedestal mount;
injecting the thermoplastic resin in a molten state from the injection port; and
picking up the pedestal mount from the injection molding metal mold after the thermoplastic resin is hardened.

25. A hot melt molding method as claimed in claim 24, wherein a plurality of the groove portions are formed in the pedestal mount, and the pedestal mount is installed in the injection molding metal mold in such a manner that one of a plurality of groove portions is positioned in an air escape portion of the injection molding metal mold.

26. A hot melt molding method as claimed in claim 24, wherein a portion protruding from the outer surface in the thermoplastic resin existing in the vicinity of the groove portion is cut after picking up the pedestal mount from the injection molding metal mold.
